(19) United States
(12) Patent Application Publication
(10) Pub. No.: US 2026/0021827 A1
(43) Pub. Date: Jan. 22, 2026

(54) TRAFFIC SYSTEM FOR CONTROLLING VEHICLES

(71) Applicant: Continental Automotive Technologies GmbH, Hannover (DE)

(72) Inventors: Peter Quittenbaum, Bad Vilbel (DE); Ulrich Stählin, Eschborn (DE)

(73) Assignee: Continental Automotive Technologies GmbH, Hannover (DE)

(21) Appl. No.: 19/273,057

(22) Filed: Jul. 17, 2025

(30) Foreign Application Priority Data
Jul. 18, 2024 (DE) 10 2024 206 742.3

(51) Int. Cl. B60W 60/00; B60W 10/04; B60W 10/18; B60W 10/20

(52) U.S. Cl. CPC B60W 60/0011; B60W 10/04; B60W 10/18; B60W 10/20; B60W 2530/201; B60W 2556/45; B60W 2710/18; B60W 2710/20

(57) ABSTRACT

A traffic system for controlling vehicle, wherein the traffic system controls a vehicle located in a traffic area, comprises a control unit and a communication unit for communication between the traffic system and the vehicle, wherein the traffic system can control the vehicle by at least two different control methods, having the following steps before entering the traffic system for the first time, registering the vehicle and verifying which of the control methods can be applied, checking in before each further entry into the traffic system, wherein during check-in a preferred control method is selected from the control methods applicable to the vehicle, in particular by the control unit, and the vehicle is moved through the traffic area using the selected control method.

### TECHNICAL FIELD

The embodiments relate to a traffic system for controlling vehicles.

### BACKGROUND

Automation is becoming increasingly common in many areas of daily life in order to support people in their activities or completely relieve them of tasks. For this reason, traffic systems, in particular parking systems, are also being developed, which relieve the driver or the occupants of a vehicle of the task of parking the vehicle. To do this, the traffic system must control the vehicle located in a traffic area from a starting point to a destination.

The vehicle can be controlled in different ways, as not every vehicle has the same control methods for steering the vehicle. The first method is via the vehicle itself, wherein the vehicle transmits the route or the destination to the traffic system. Secondly, the selection can be made by the traffic system. However, the problem is that the distribution of control methods between the vehicle and the infrastructure allows for a large number of different variants, which also result in different data in the information exchange between the infrastructure and the vehicle.

### SUMMARY

The object is to propose a traffic system for controlling vehicles, which makes the selection of the control method for the vehicle more efficient and/or allows a handshake to be used for dividing the control method between vehicle and infrastructure.

To achieve this object, a traffic system for controlling vehicles is provided. The traffic system controls a vehicle located in a traffic area. The traffic system comprises a control unit and a communication unit for communication between the traffic system and the vehicle. The traffic system can control the vehicle by at least two different control methods. The traffic system has the following steps: before entering the traffic system for the first time, registering the vehicle and verifying which of the control methods can be applied, checking in before each further entry into the traffic system, wherein at check-in a preferred control method is selected from the control methods applicable to the vehicle, for example by the control unit, and the vehicle is moved through the traffic area using the selected control method.

A traffic system refers to systems that are suitable for controlling and/or monitoring vehicles. The traffic system comprises a control unit and a communication unit for communication with the vehicle.

A traffic area is the region in which the traffic system can control and/or monitor the vehicle. The traffic area can be defined, for example, by the range of the communication unit or physical elements that can be detected by sensors, for example.

A control unit is understood to mean any type of computing unit which can perform calculations, for example for a trajectory of the vehicle, and/or generate control commands. For example, a control unit can be a central unit such as a microcontroller or a CPU (Central Processing Unit), or a decentralized unit such as a server.

A communication unit is a unit that enables communication between the vehicle and the traffic system. The communication may take place wirelessly. For example, a communications unit can be an FM or WLAN transmitter.

A control method is understood to mean a method by which the traffic system can control the vehicle or the vehicle can control itself in the traffic area. The control methods include for example control loops and/or the calculation and transmission of waypoints.

A preferred control method is the control method with which the vehicle can be controlled with the least effort. The preferred control method with the least effort is, for example, the control method with the least amount of data traffic or that requires the least amount of effort to coordinate the vehicle in the traffic area. Criteria for selecting the control method can be stored, for example, the volume of data or the number of steps for controlling the vehicle. The preferred control method may be for example selected by the traffic system. The preferred control method can be selected, for example, on the basis of a control of the vehicle previously carried out

Registration means the first time that the vehicle enters the traffic system. The traffic system stores vehicle data, with which the vehicle can be uniquely identified. The registration can be carried out, for example, by the traffic system itself, in which it requests vehicle data from the vehicle. Alternatively, the vehicle can transmit the vehicle data when entering the starting point of the traffic system for the first time. The vehicle data can contain, for example, control variables and/or manipulated variables of the vehicle. It may also contain the license plate and/or vehicle brand and/or model and/or color that are unique to the vehicle.

A check-in may be understood to mean each further entry into the traffic system made by the vehicle. In this case, vehicle data may be requested from the vehicle by the traffic system, which data can be used to uniquely identify the vehicle, for example an official license plate. This vehicle data is compared with vehicle data stored in the traffic system. The preferred control method that is stored for the vehicle is then selected. Alternatively, in its starting position the vehicle may transmit the vehicle data which can be used to uniquely identify the vehicle. The traffic system then compares the vehicle data and, if there is a match, selects the preferred control method for the vehicle. Thus, the control method can be selected more quickly.

The verification of the control methods that can be used means a comparison of the control methods that the traffic system can support or carry out against the control methods that the vehicle can support or carry out. For example, the comparison can be made in such a way that the system prompts the vehicle to transmit the control methods that the vehicle can support to the traffic system. Alternatively, the vehicle can already transmit the possible control methods to the traffic system during registration.

Thus, the division of the control loop used to control the vehicle between the vehicle and the traffic system is simplified.

The verification by the traffic system can be effected by querying the possible control methods from the vehicle and/or by the vehicle transmitting the possible control methods to the traffic system. This allows the division of the control loop used for controlling the vehicle between the traffic system and the vehicle to be speeded up.

Furthermore, the traffic system comprises at least one sensor for identifying the vehicle and/or for collecting vehicle information, wherein the selection of the control method and/or the identification and/or the movement of the vehicle take into account the identification of the vehicle and/or the vehicle information collected. The vehicle can be identified, for example, on the basis of the number plate and/or the color and/or the make and/or the indicator and/or the light. For example, the indicator and/or the light can generate a pattern defined by the traffic system or the vehicle, which the sensors detect. Thus, the vehicle can be uniquely identified.

In addition, the vehicle information items can be the length and/or width and/or height and/or a steering radius of the vehicle, which are detected by the at least one sensor. The traffic system can detect the vehicle information itself, allowing

The vehicle may transmit vehicle data to the control unit by means of the communication unit, wherein the vehicle data comprises control variables for a steering system and/or a braking device and/or a drive and/or a length, a width and a height of the vehicle. The transmission of vehicle data to the traffic system by the vehicle includes more accurate vehicle data than can be detected by sensors, which allows the vehicle to be controlled more accurately.

Furthermore, the control method selected by the traffic system can be communicated to the vehicle and/or the control method can be selected by the vehicle. This makes it easier to coordinate the traffic system and the vehicle with regard to the control methods and the associated control variables and/or control commands.

The traffic system can select the preferred control method, should at least two control methods be available. This enhances the selection of the preferred control method by reducing the number of communication steps between the traffic system and the vehicle. For example, the traffic system begins the communication and specifies the preferred control method to the vehicle. This does not involve coordination with the vehicle. Thus, the traffic system can better plan capacities, i.e. an overview of all vehicles in the traffic system, or is able to select the ideal method for controlling all vehicles.

A first control method of the control methods can comprise control instructions for manipulated variables of the vehicle, for example for a steering and/or a braking device and/or a drive. Thus, the traffic system can control the vehicle precisely, because this gives the traffic system full control over the vehicle.

A second control method of the control methods may include the transmission of waypoints and/or a route, and checking whether the vehicle is moving along the waypoints and/or the route. The waypoints are identified by the control unit and transmitted to the vehicle by the communication unit. The vehicle then moves independently from waypoint to waypoint. Alternatively, the control unit can determine a route, which is transmitted to the vehicle by the communication unit and along which the vehicle travels independently. The traffic system checks whether the vehicle is moving along the waypoints and/or the route. In the event of a deviation from the waypoints and/or the route, the traffic system can transmit a control command to the vehicle, which stops the vehicle and/or performs a correction.

The control unit may identify waypoints through the traffic area, with the waypoints and/or the route being based on the vehicle data transmitted by the vehicle. The vehicle uses sensors in the vehicle to determine environmental data on the objects and/or driving routes in the surroundings. This environmental data is transmitted to the traffic system via the communications unit. The control unit uses this environmental data to determine the waypoints and/or the route and sends them back to the vehicle by means of the communication unit. This allows the traffic system to control the vehicle without sensors located in the traffic area of the traffic system.

Furthermore, the control methods can comprise controlling the vehicle based on a vehicle-internal sensor system and/or control based on the sensors of the traffic system. If the vehicle is controlled on the basis of the vehicle-internal sensor system, the presence of sensors in the traffic system can be omitted. If the vehicle is controlled on the basis of the sensors of the traffic system, the presence of a vehicle-internal sensor system can be omitted. If the vehicle is controlled on the basis of the vehicle-internal sensor system and the sensors of the traffic system, the control of the vehicle can be enhanced and/or a redundancy can be created in the control methods.

The control unit can comprise a database, wherein the database comprises and/or stores all relevant vehicle data and/or vehicle information for the control method of the vehicle. The database can include information on vehicles provided by vehicle manufacturers. In addition or alternatively, the database can already include vehicle information and/or vehicle data from a vehicle in communication with the traffic system. Thus, making the selection of the control method faster.

Information involves for example information about the possible control methods. The information can include the vehicle data and/or vehicle information.

### BRIEF DESCRIPTION OF THE DRAWINGS

Further features will become apparent from the following description in connection with the appended drawings. In the drawings:

FIG. 1 shows an example of the structure of a traffic system

FIG. 2 shows a schematic procedure for coordinating the control method

FIG. 3 shows a schematic procedure according to FIG. 2 with selection of the control method

### DETAILED DESCRIPTION

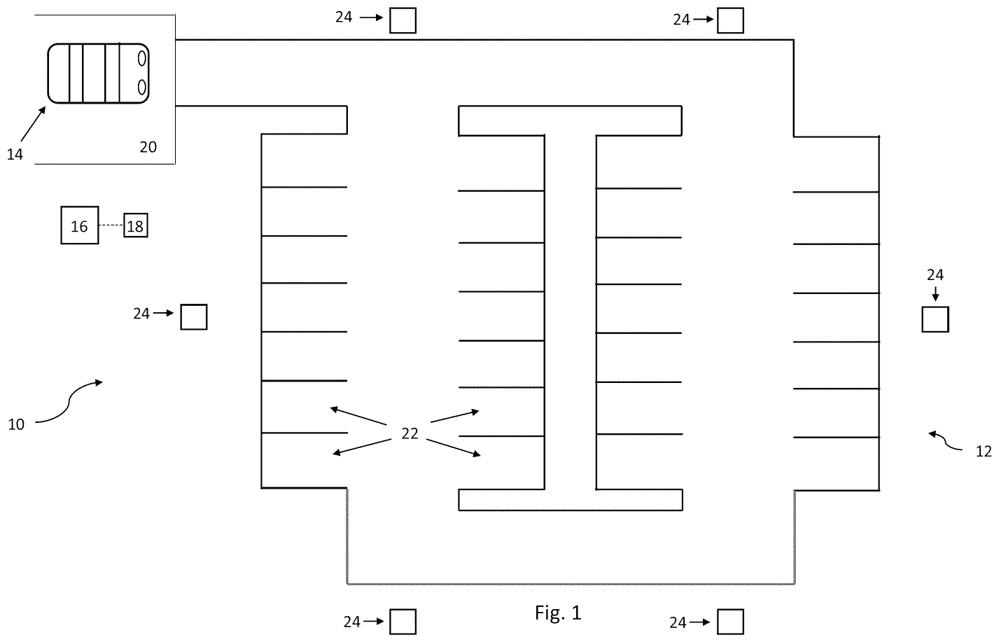

FIG. 1 shows a traffic system 10 with a vehicle 14 located in a traffic area 12, wherein the traffic system 10 has a control unit 16 and a communication unit 18. The control unit 16 and the communication unit 18 are connected wirelessly or by wires.

The vehicle 14 is controlled by the traffic system 10 from a starting point 20, also referred to as the transfer area 20, to a destination 22, also referred to as parking space 22, by so-called control methods in the traffic area 12. The control methods include common control systems and their design from the field of control engineering. In the control method, trajectories or routes are transmitted from the traffic system 10 to the vehicle 14. The vehicle 14 follows these trajectories or routes from the starting point 20 to the destination 22. Actual values, i.e. the exact position of the vehicle 14, are compared with target values, i.e. the transmitted trajectories or routes. The actual values are determined via the sensors 24.

The traffic system 10 uses the communication unit 18 to establish a connection, via which vehicle data and/or control commands are transmitted. The control commands are generated by the control unit. The vehicle data is provided by the vehicle 14. A communication unit located in the vehicle 14, which is not shown, receives the control commands. The connection may be implemented as a wireless link.

The control of the vehicle 14 can be based on different control methods, since not every vehicle 14 can support or perform the same control methods. For this reason, it is necessary to coordinate between the traffic system 10 and the vehicle 14 over which control method can be used.

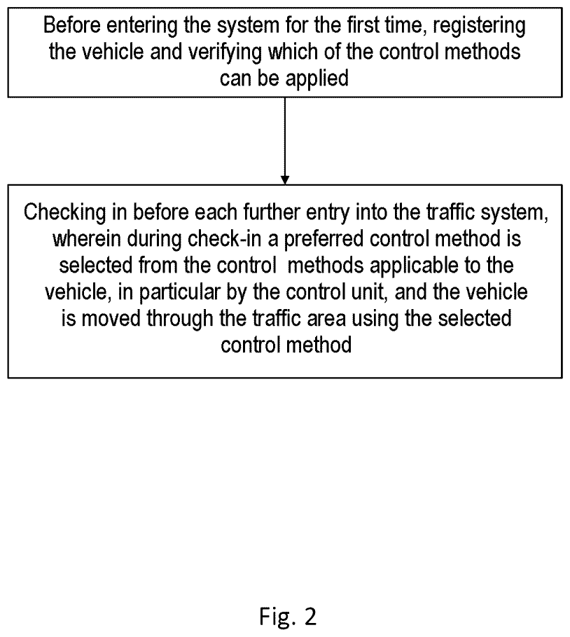

In FIG. 2, a schematic procedure is shown, illustrating how a coordination between the traffic system 10 and the vehicle 14 takes place. The vehicle 14 is parked in the transfer area 20 by a driver or occupant. The traffic system 10 establishes a connection to the vehicle 14 by means of the communication unit 18. When the vehicle 14 enters the traffic area 12 of the traffic system 10 for the first time, the vehicle 14 undergoes registration. During registration, a check is also carried out to determine which control method(s) the vehicle 14 supports. The traffic system 10, for example, makes a request to the vehicle 14 as to which control methods are supported by the vehicle 14. After the vehicle 14 has transmitted the possible control methods to the traffic system 10, the traffic system 10 decides which control method will be applied. The selection can be made, for example, on the basis of the control variables available for the control system. The selected control method is transmitted to the vehicle 14. Subsequently, the control and transmission of the control commands and/or data to the vehicle 14 begins, wherein the data comprises waypoints and/or routes through the traffic area 12.

If the vehicle 14 is ordered by the driver or the occupants from the parking space 22 back to the transfer area 20, the vehicle 14 must check in again with the traffic system 10. When the vehicle 14 was first registered with the traffic system 10, data or information about the vehicle 14 was stored in a data memory, for example, a server (not shown). This data or information is retrieved from the traffic system 10 when the vehicle 14 checks in again. The traffic system 10 uses this data or information to select a preferred control method, which is the most recently used control method, for example. Alternatively, the control method chosen as the preferred control method can be that which allows precise control of the vehicle 14 compared to the last control method used. After selection, the vehicle 14 is moved back to the transfer area 20.

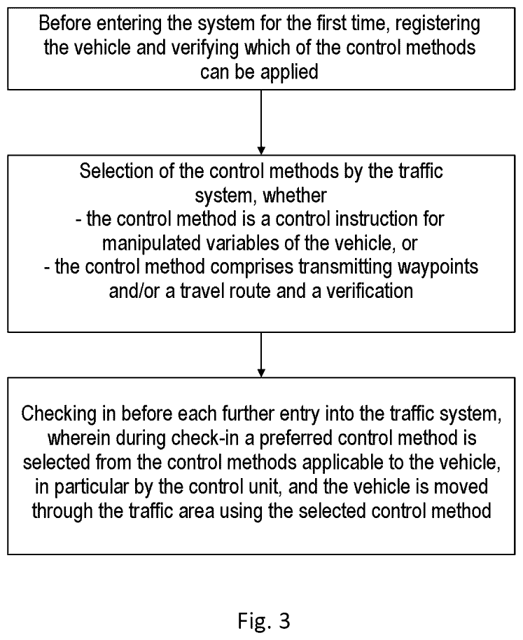

In FIG. 3, the previously explained exemplary embodiment is extended to include the selection of control methods. In this case, the traffic system 10 selects the control method. There are essentially two control methods to choose from. The first control method of the control methods is a control instruction for manipulated variables of the vehicle, for example for a steering and/or a braking device and/or a drive. The second control method of the control methods includes the transmission of waypoints and/or a route and checking whether the vehicle is moving along the waypoints and/or the route. The vehicle 14 transmits which of the two control methods it supports. The traffic system 10 then selects one of the control methods. The selection can be made, for example, on the basis of the manipulated variables available for the control system and/or vehicle data and/or vehicle information. The traffic system 10 then controls the vehicle 14 from the transfer area 20 to the parking space 22 using the selected control method.

If the vehicle 14 is ordered back to the transfer area 20 by the driver or the occupants, the same steps as already described in FIG. 2 are carried out.

Another exemplary embodiment is based on the above examples, however, the traffic system 10 additionally comprises at least one sensor 24. The at least one sensor 24 can generate vehicle information relating to the vehicle, which can be used for the selected control method and/or for the identification of the vehicle 14. The vehicle information can be used instead of the vehicle data transmitted by the vehicle 14 or in addition to the vehicle data.

In another exemplary embodiment, the above-mentioned exemplary embodiments are extended to include a database. The database includes vehicle data provided by the manufacturer, such as control variables and/or wheelbase or a control method specific to the vehicle 14, which enables a more precise control of the vehicle 14. In addition, vehicle information that has been determined by the at least one sensor 24 can be stored in the database. The traffic system can compare the stored vehicle information and/or vehicle data on each initial entry and/or each further entry into the traffic area 12 by the vehicle 14, to determine whether vehicle information and/or vehicle data for the vehicle 14 are already held in the database. If a more precise control of the vehicle 14 can be enabled using the vehicle information and/or vehicle data included in the database for the vehicle 14 than would be possible with the vehicle data transmitted by the vehicle 14 itself, the traffic system 10 can use the vehicle information and/or vehicle data stored in the database for the control. The control method used for the vehicle 14 can also be stored in the database.

1. A traffic system for controlling vehicles comprising:
a communication unit for communication between the traffic system and the vehicle; and
a control unit, to control the vehicle by at least two different control methods, having the following steps:
registering the vehicle and verifying which of the control methods can be applied before entering the traffic system for the first time;
checking in before each further entry into the traffic system, wherein is
selecting a preferred control method with the control unit during check-in from the control methods applicable to the vehicle and the vehicle; and
moving the vehicle through the traffic area using the selected control method.

2. The traffic system as claimed in claim 1, wherein the verification further comprises at least one of querying the possible control methods from the vehicle and transmitting the possible control methods from the vehicle to the traffic system.

3. The traffic system as claimed in claim 1, wherein the traffic system comprises at least one sensor for at least one of identifying the vehicle and collecting vehicle information, wherein at least one of the identification of the vehicle and the vehicle information collected take into account at least one of: the selection of the control method, the identification of the vehicle and the movement of the vehicle.

4. The traffic system as claimed in claim 3, wherein the vehicle information item is at least one of length, width, height, and a steering radius of the vehicle, which is detected by the at least one sensor.

5. The traffic system as claimed in claim 1, wherein the vehicle transmits vehicle data to the control unit by means of the communication unit, wherein the vehicle data comprises control variables for at least one of a steering system, a braking device, a drive, a length, a width and a height of the vehicle.

6. The traffic system as claimed in claim 1, wherein at least one of the control method selected by the traffic system is notified to the vehicle and the control method is selected by the vehicle.

7. The traffic system as claimed in claim 1, wherein when at least two control methods are available the traffic system selects the control method.

8. The traffic system as claimed in claim 1, wherein a first control method of the control methods is a control instruction for manipulated variables of the vehicle for at least one of a steering device, a braking device and a drive unit.

9. The traffic system as claimed in claim 1, wherein a second control method of the control methods comprises at least one of: the transmission of waypoints, a travel route and checking whether the vehicle moves along the waypoints, and the travel route.

10. The traffic system as claimed in claim 1, wherein the control unit identifies waypoints through the traffic are, the waypoints being identified on the basis of the vehicle data transmitted by the vehicle.

11. The traffic system as claimed in claim 1, wherein the control methods comprise at least one of control of the vehicle based on a vehicle-internal sensor system and control based on the sensors of the traffic system.

12. A method comprising:
registering a vehicle with a traffic system and verifying with a control unit for the traffic system, which of the control method can be applied before entering the traffic system for the first time;
checking in before each further entry into the traffic system, wherein is selecting a preferred control method with the control unit during check-in from the control methods applicable to the vehicle and the vehicle; and
moving the vehicle through the traffic area using the selected control method.

13. The method of claim 12, wherein the control unit comprises a database, wherein the database at least one of comprises all relevant vehicle data, stores all relevant vehicle data, and vehicle information for the control method of the vehicle.
